(19) United States
(12) Patent Application Publication
(10) Pub. No.: US 2010/0036844 A1
(43) Pub. Date: Feb. 11, 2010

(54) SYSTEM AND METHOD OF USING CONFLICTS TO MAXIMIZE CONCURRENCY IN A DATABASE

(75) Inventors: Thomas C. Butler, Santa Clara, CA (US); William Leonard Mills, Battle Ground, WA (US)

Correspondence Address: BERRY & ASSOCIATES P.C., 9229 SUNSET BOULEVARD, SUITE 630, LOS ANGELES, CA, 90069, US

(73) Assignee: ACCESS CO., LTD., Tokyo (JP)

(21) Appl. No.: 12/580,246

(22) Filed: Oct. 15, 2009

Related U.S. Application Data
(63) Continuation-in-part of application No. 10/972,965, filed on Oct. 21, 2004.
Application No. 10/972,965 is a continuation-in-part of application No. 11/966,950, filed on Dec. 28, 2007.

(51) Int. Cl. G06F 17/30

(52) U.S. Cl. 707/8; 707/E17.007

(57) ABSTRACT

A first method includes requesting a modification of a data object within the data store using a first application process, establishing a read lock on the data object, initializing an object monitor adapted to detects changes to the data object and releasing the read lock, allowing other concurrent processes to write to the data object, wherein the object monitor detects if any of the concurrent processes overwrite the data object. A second method includes requesting a modification of a data object within the data store using a first application process, establishing a read lock on the data store, initializing a datastore monitor adapted to detect changes to the data store, reading all data objects in the data store and releasing the read lock on the data store, allowing other concurrent processes to write to the data store wherein the datastore monitor detects if any of the concurrent processes overwrite one or more data objects in the data store.

### CROSS-REFERENCE TO RELATED APPLICATIONS

The present application is a continuation-in-part of and commonly-assigned U.S. patent application Ser. No. 10/972,965 entitled “Determining Priority Between Data Items in Shared Environments” and U.S. patent application Ser. No. 11/966,950 entitled “Determining Priority Between Data Items,” both of which are incorporated by reference in this application. The present application also incorporates by reference the disclosures in U.S. patent application Ser. No. 10/159,077 entitled “Generating Coherent Global Identifiers for Efficient Data Identification” issued as U.S. Pat. No. 6,934,710 and U.S. patent application Ser. No. 10/159,461 entitled “Determining Priority Between Data Items in Shared Environments” issued as U.S. Pat. No. 7,337,193.

### BACKGROUND OF THE INVENTION

1) Field of the Invention

The present invention relates generally to the field of databases. Specifically the present invention focuses on increasing concurrent access of data through the use of data conflicts.

2) Background

Individuals now commonly use numerous computing devices and information appliances to store and communicate information. For example, a person may use portable computing devices such as a smart cell phone or personal digital assistant (PDA) while in transit, and a lap top or desk top computer system while at work or at home. Furthermore, a user may store data to enable viewing the data by others via an internet or intranet site on a server system. It is common for a data set to be maintained on a plurality of these devices. For example, a user may maintain a calendar or address book on both a PDA and a desktop or laptop computer system.

The entries in the data set may be referred to as records or data objects. When a change is made to a record in the data set residing on one device (hereinafter also referred to as a node), it is desirable to have the data set on the other node be updated as well, so that the data set is synchronized on both nodes. Accordingly, processes have been developed to facilitate synchronization of the data sets of both nodes. However, as computer systems are networked, multiple communication pathways between PDAs and computer systems can exist, and synchronization between multiple devices needs to be supported.

This added complexity is not just present in the number of computers we carry and use but is also represented in the complexity of the programs installed and the number being executed at a given time. This increased complexity means that the finite resources of computer systems are always being fought over by competing applications. Other than just competition for resources an ever increasing number of applications and programs require access to the same data in a preferably timely manner.

In the realm of computer database systems it is not unusual for there to be more than one program referencing or requiring access to the same data item. This however can cause conflicts as, for example, program A might modify an object O that program B might also require access to. If program A is trying to write to object O while program B is reading object O, this would possibly create corrupt data that is being read by program B. Traditionally, a method for preventing such conflicts is to use, for example, Locks. The use of Locks though has the major disadvantage that while a lock is placed on an object the object can not be read or written to by other objects until the lock is released. This is of particular issue when the object or process that holds the lock requires some user action. This is not just an issue for concurrent access of data but it can also be an issue of data being altered by another program, without the program being aware of the alteration.

What is therefore needed is a technique that allows concurrent writes to a data store without requiring a lock to be maintained on the data store between reading and writing of data.

### SUMMARY OF THE INVENTION

In an exemplary embodiment, the present invention provides a method of providing data concurrency in a data store having a plurality of data objects. The method includes requesting a modification of a data object within the data store using an application process, establishing a read lock on the data object, initializing an object monitor adapted to detect changes to the data object and releasing the read lock to allow other concurrent processes to write to the data object wherein the object monitor detects if any of the concurrent processes overwrite the data object.

In another exemplary embodiment, the present invention provides a method of increasing concurrency in a database through creating conflicts. The method includes determining whether to make edits to a data object in a datastore using an application process, establishing a read lock on the data object, using an object monitor applied to the data object at the commencement of editing to determine whether the data object has been modified between commencement and finalization of the edits, and creating a new version of the data object if it is determined that the data object has been modified.

In another exemplary embodiment, the present invention provides a more efficient and convenient method for monitoring changes to a collection of objects than the equivalent collection of object monitors. The method includes the steps of establishing a read lock on the data store, initializing a datastore monitor adapted to detect changes to the data store, reading all data objects in the data store, and releasing the read lock on the data store to allow other concurrent processes to write to the data store wherein the datastore monitor detects if any of the concurrent processes overwrite one or more data objects in the data store.

The above exemplary embodiments are not meant to restrict the scope of this application. Though not enumerated in the above embodiments the programs attempting to access data need not be running locally, but rather may be running on networked devices connected by other means, for example, either wired or wireless.

Additional features and advantages of the invention will be set forth in the description which follows, and in part will be obvious from the description, or may be learned by practice of the invention.

### BRIEF DESCRIPTION OF THE DRAWINGS

FIG. 1 is a block diagram of an exemplary network system of networked computing devices.

FIG. 2 is a block diagram of an exemplary portable computing device.

FIG. 3 is a flow diagram of a method of preserving a modification using an object monitor according to an embodiment of the present invention.

FIG. 4 is a flow diagram of an exemplary method of providing data concurrency which follows the steps shown in FIG. 3.

FIG. 5 is a flow diagram of a method of providing data concurrency in a data store using a datastore monitor according to an embodiment of the present invention.

FIG. 6 shows an exemplary datastore monitor listing according an embodiment of the present invention.

FIG. 7 illustrates the operating steps of a read process using a datastore monitor.

FIG. 8 is a flow diagram with operating steps that are an extension of FIG. 4.

### DETAILED DESCRIPTION

A data object, such as a file or record, typically has two properties of interest, an identity (or identifier) and content. The identity property allows two data objects to be compared to determine whether they represent the same data. Data objects having the same identity may then be compared for content. Thus, for example, the same data object O may be stored in a portable computing device (P) and on a desktop computer (D). If data object O is modified on the portable computing device (P) but not on the desktop computer (D), then a situation exists where data objects having the same identity have different content on the respective devices. When a data object is modified in a node, a presumption of priority is made where the modified data object takes precedence over the previous version of the object and that accordingly, descendant data takes precedence over ancestor data.

By including ‘pedigree’ information that preserves edit priority, conflicts in which data objects having the same identity but different content can be resolved. The pedigree may be viewed as a change history of a data item and may include a node identifier indicating the device at which the data item is stored, and a counter such as a sync counter (which increments after each synchronization event). For example, a record created at a desktop computer with node identifier “D” and current sync clock counter at 21 is said to have pedigree D21. During a synchronization event, another computing device such as the portable computing device may receive a copy of the data item. If the data item is then subsequently modified on the portable computing device, the pedigree of the data item stored on the portable computing device is updated to include a new node identifier and counter. For example, the pedigree D21 may become D21P43 where P identifies the portable computing device and 43 is the value of the portable's sync counter at the time of the modification. Another way that the pedigree may be modified is, for example, if the data object is modified after a synchronization event, the sync counter is incremented to 22 for the desktop and the pedigree is D22. The incrementing of the sync clocks occurs before the synchronization. Then, if the object were to be modified again before the next synchronization, the pedigree would not change because the clock has not been ticked. Further an object has an associated modification count, which ticks whenever the object is modified, this allows for the tracking of versions as apposed to simply tracking the broad modification of an object. Another method that could be used would be to tick the sync clock whenever an object is modified allowing for versions to be tracked by the changing pedigree, however this method would use an increased number of sync clock increments, as above the same is realized through the use of two separate clocks.

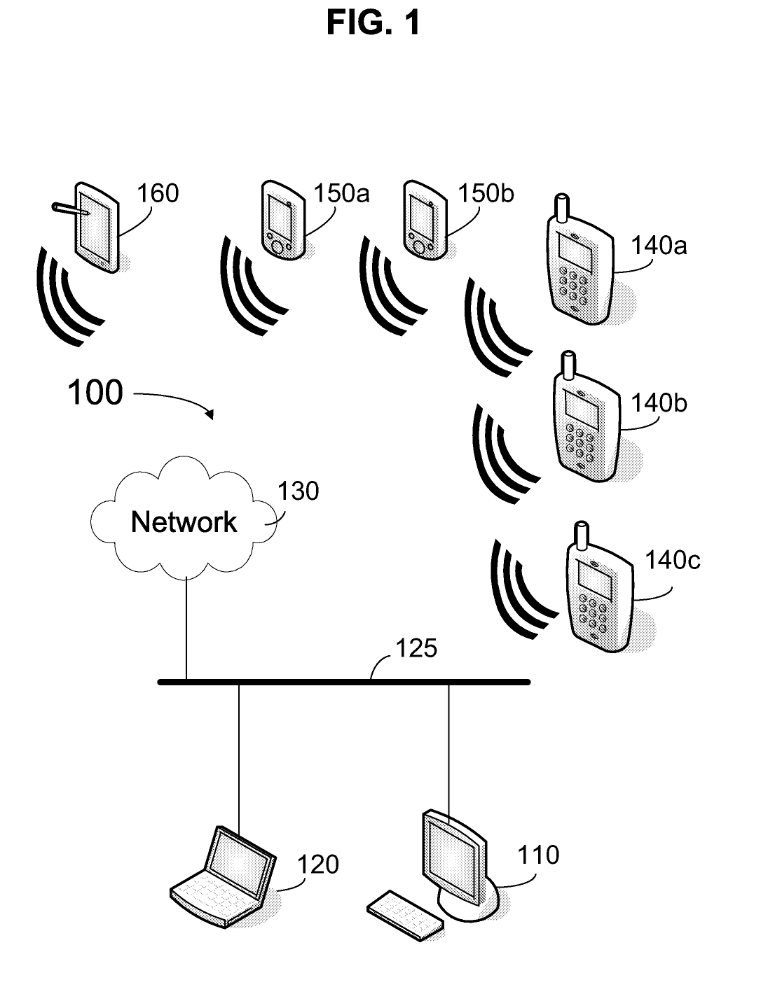

As noted above, a plurality of devices in a networked system may be synchronized so that each node of the system obtains the most up-to-date version of a set of data. FIG. 1 shows an exemplary system 100 of networked computing devices. This system 100 will be used in describing the methods of the present invention below. However, this system is merely exemplary in that the present invention is applicable to any device having data storage capability and to any plurality of devices requiring synchronization.

Referring again to FIG. 1, the system 100 includes a desktop computer 110 and a laptop computer 120 coupled to a data communication bus 125. The data communication bus 125 may comprise, for example, a serial communication bus, a parallel bus, an Ethernet LAN link, Wireless connection, and the like. The bus 125 may provide communication with one or more servers on a network 130, for example, a Wide Area Network, Local Area Network or any collection of systems interconnected, using a number of well known network protocols to dictate the communications traffic. A larger heterogeneous network may contain a wide variety of computer devices. For example, three such types of portable computer devices depicted in FIG. 1 are cellular telephones 140a-c, personal digital assistants (PDA) 150a-b, and a tablet PC 160. Cellular telephones are beginning to merge with PDAs, an example of such convergence would be a Palm™ Treo™, and although depicted separately, the present invention is intended to include converged device that share the same or similar characteristics. Cellular telephones' complexity is ever increasing, including their organizational needs, and as such require access to data as well as being available for other systems to access its data. In general, cellular telephones use a wireless protocol for making data connections, for example, Bluetooth, Wifi, a Cellular Network or a cable and dock configuration which electrically and mechanically tethers the device to another computer. For purposes of this example, PDAs 150a-b are devices that have all of the communications requirements of modem cellular telephones. Similarly, tablet PC 160 is depicted in FIG. 1 having the capability to wirelessly communicate with network 130. Tablets are taking the place of PDA's in some sectors especially in the medical field where they are often used as part of paperless chart systems for doctors and hospitals.

The laptop computer 110, the desktop computer 120, the cellular phone 140a-c, PDA 150a-b and the Tablet PC 160 all can include one or more processors for running an operating system and executing program applications or coprocessors designed to offload specific tasks from the CPU. The devices 110, 120, 140a-c, 150a-b and 160 can include local or attached memory, including, for example, volatile (RAM) and non-volatile (ROM) memory for storing data. In preferred embodiments, the computing devices 110, 120, 140a-c, 150a-b and 160 of the system 100 all operate on a Linux-based platform such as the Access Linux Platform (ALP), but the present invention is also applicable in systems in which other operating systems are adapted for mobile/portable devices and information appliances such as Symbian, Windows Mobile, Blackberry OS, and the like.

Each of the computing devices 110, 120, 140a-c, 150a-b and 160 may execute personal information management (PIM) applications including calendar, address book and email applications. Information input by a user of such applications is initially stored locally in data stores located on each of the devices 110, 120, 140a-c, 150a-b and 160. As discussed further below, the data stores on the devices may be duplicative to the extent that the same data objects are stored in each node (device). For example, appointment information on a personal calendar may be stored on each of the devices for easy access regardless of which device the user is currently operating.

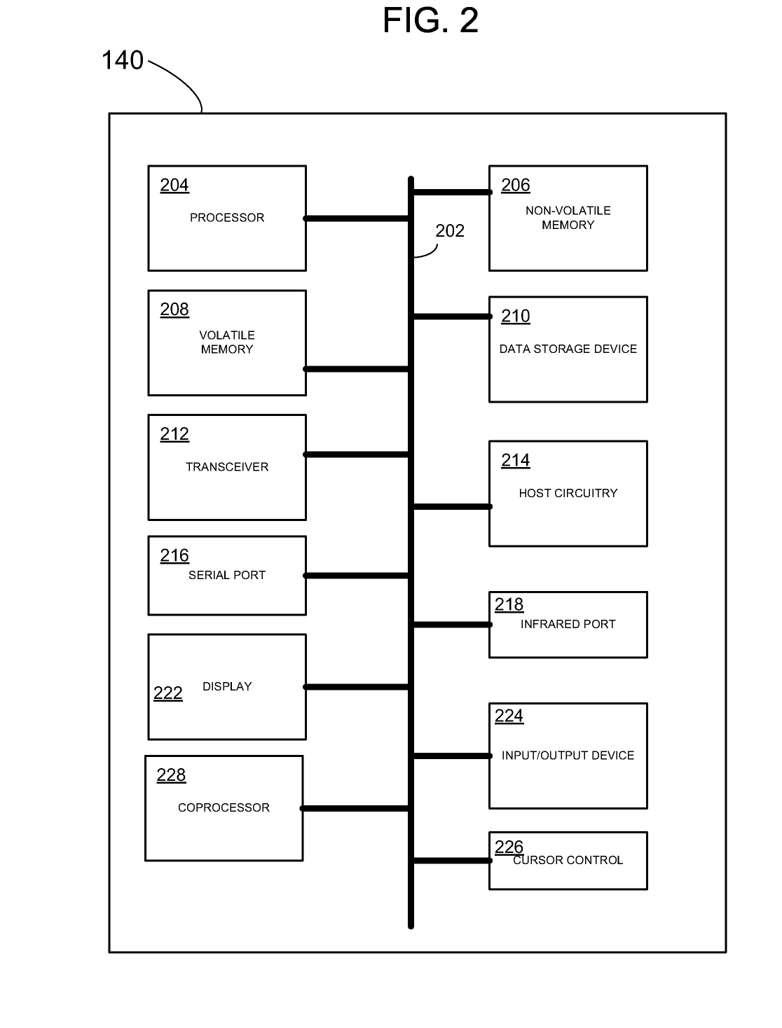

FIG. 2 is a block diagram showing functional components of an exemplary computing device 140, such as 110, 120, 140a-c, 150a-b and 160 in which embodiments of the present invention may be implemented. In one embodiment, the computing device 140 may include an address/data bus 202 to which the functional components of the device 140 are coupled for inter-communication. The functional components include a central processor 204 adapted to run an operating system and to execute tasks and applications over the operating system platform. The central processor can consist of multiple processors or cores and may be part of a distributed network of processors. The central processor 204 may utilize memory resources of a non-volatile memory 206 (for example, ROM, programmable ROM (PROM), erasable and electrically-erasable programmable ROM (EPROM, EEPROM or flash ROM), EPROM, EEPROM) and a volatile memory 208 (for example, SRAM, DRAM) in its operations. The volatile memory 208 may store organized structures of records such as data stores discussed above and in further detail below. The computing device 140 may further include an optional data storage device 210 such as a secure digital card or media card which may be removable.

The computing device 140 may be equipped with or coupled to a transceiver 212 enabling a wireless communication link to a wireless base station (not shown). In some embodiments, the computing device 140 may communicate with other devices in the networked system via a base station and gateway (not shown). The transceiver 212 is coupled to host circuitry 214 which may comprise or include a digital signal processor (DSP) for processing received/transmitted data. The host circuitry may also include an asynchronous receiver-transmitter (UART) module that provides serial communication capability via a serial port 216 and IR (infrared) port 218. Alternatively, the processor 202 may perform some or all of the functions performed by the host circuitry 214.

The computing device 140 may also be equipped with a coprocessor 228. A coprocessor would be used to handle advanced application specific tasks that would otherwise take valuable system resources. The coprocessor 228 may also be a DSP used, for example, for audio processing in voice recognition or text to speech systems or a Field Programmable Gate Array (FPGA) that could be programmed to perform application specific tasks.

The computing device 140 may also be equipped with input/output devices including a display device 222 such as a screen or a haptic display, an alphanumeric input/output device 224, and an optional on-screen cursor control 226 for communicating user input and command selection to the processor 204. The input/output device 224 may also be a GPS device or any device that may require some input/output of data connecting to the system following known protocols. In various embodiments, the computing device 140 may include other elements not shown in FIG. 2.

In accordance with embodiments of the present invention, an object monitor allows concurrent writes (modifications) on a shared data object in a data store without requiring a program to maintain a read lock on the data store between the reading and writing of data. The object monitor enables determinations as to whether a data object has changed since it was read, and more generally enables determinations as whether data objects in a data store have changed since a given check point.

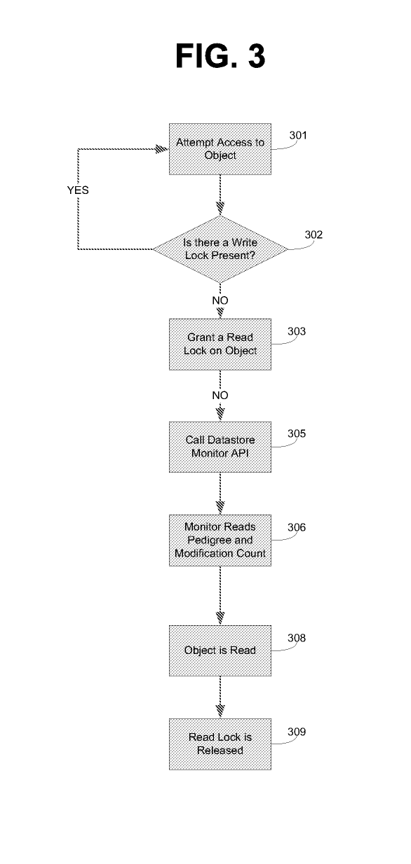

FIG. 3 is a flow diagram of a method of preserving a modification using an object monitor according to an exemplary embodiment of the present invention. Initially, a process A running on one of the devices of system 100 in FIG. 1, for example a PDA 150a, executes a command to modify a data object O2 stored locally in data store (P), and which may also be shared in data stores on other devices in FIG. 1. Since the data object O2 is shared, other processes executed may make concurrent attempts (for example, during a synchronization process) to modify the same data object in data store (P). Process A may be a user application that enables (and waits for) a user to modify a data object O2 (such as an address record in a contact database, an appointment record in a calendar database, etc.) through direct input.

Referring to FIG. 3, a read operation on an object in a datastore is performed by a program. Initially, the program attempts to access the object, step 301. To do so the program checks for an existing write lock on the object before accessing, step 302, to prevent corruption or an incorrect read of the object. If a write lock exists, the program must wait and attempt to access the object again when the lock is not present. If a write lock is not present on the object, then the process may access the object and a read lock is granted, step 303. At step 305 the program creates a monitor by calling the object monitor API, which then stores the object's pedigree and modification count, step 306. Then the process proceeds to read the object, step 308. After reading the object, step 308, the process releases its lock, step 309.

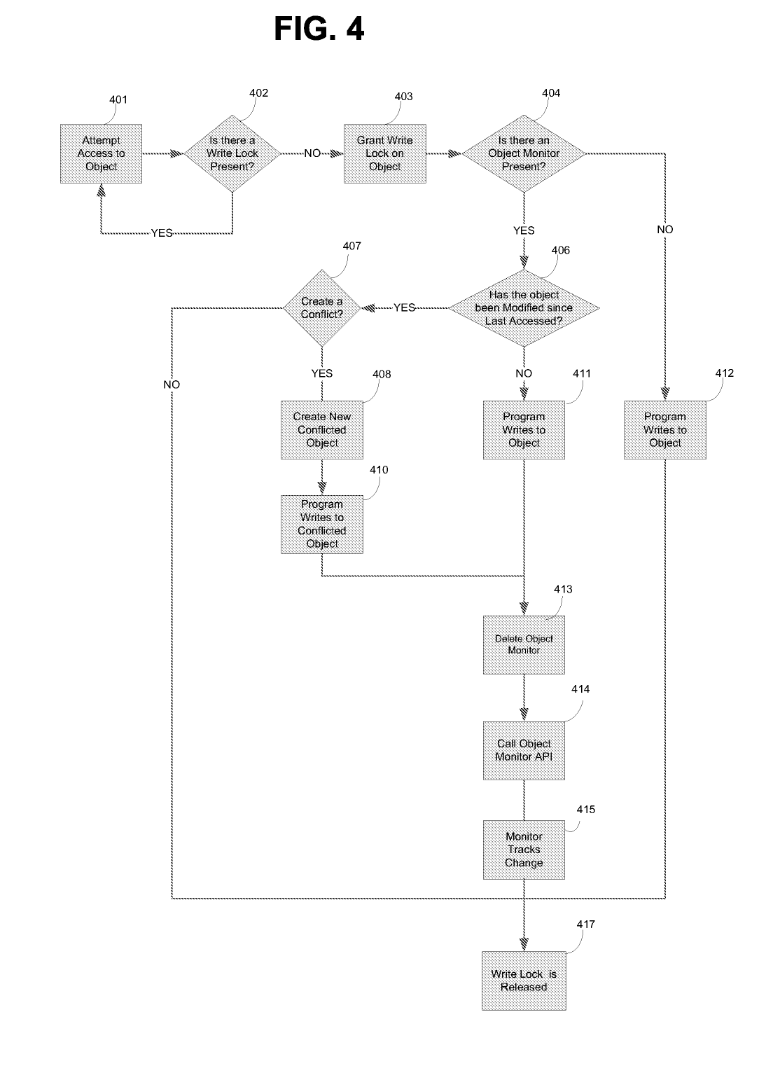

FIG. 4 is a flow diagram of an exemplary method of a write operation on an object in a datastore performed by a program. Initially, the program attempts to access the object, step 401. To do so the program checks for an existing write lock on the data-store before accessing, step 402, to prevent corruption or collisions. If a lock exists the process must wait and attempt to access the datastore again when a write lock is not present. If a write lock is not present on the datastore, then the process may access the datastore and a write lock is granted, step 403. The process then checks for a current monitor on the datastore, step 404. If no monitor is present the system goes directly to writing to the object at step 412. If a monitor was present on the object the system next determines whether the object has been modified since the monitor was acquired, the pedigree and modification stored in the monitor are compared with the object's current pedigree and modification count, step 406. If the object has not been modified, then the program is allowed to write to the object, step 411. The system then deletes the monitor and at step 413 and goes on to call the object monitor API to create a new monitor for the object at step 414. The monitor then reads the object's new pedigree and modification count, step 415, then the lock is released, step 417. If the object has been modified, then based on certain conditions the system determines whether to create a conflict or abort the write process, step 407. If the program creates a conflict, the object's current content is saved and a conflicted object is created, step 408, the system then writes to the conflicted version of the object at step 410. The system then advances to step 413 and follows the same course as previously outlined. If the process aborts the write process by choosing to not create a conflict, then the system advances directly to step 417 and releases the write lock.

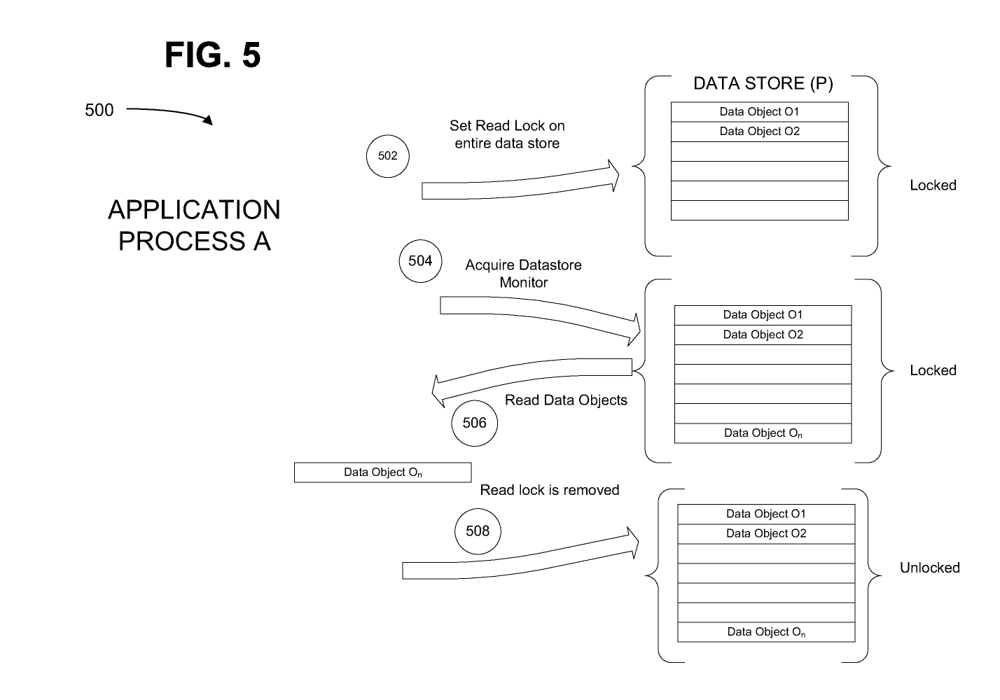

The inventive principles of ensuring data concurrency of individual data objects described above may be extended and applied to a larger set of data such as a datastore by means of a datastore monitor. The flow diagram of FIG. 5 shows an exemplary method 500 in accordance with the present invention that preserves a modification using a datastore monitor. In step 502, process A obtains a lock on the entire data store (P). In step 504, process A calls an API that initializes a datastore monitor. In step 506, process A reads the data objects from the data store and then, in step 508, releases the read lock on the data store (P). In preferred embodiments, the datastore monitor is implemented as a ‘notepad’ to record changes since the monitor was acquired. The datastore monitor is initially empty and when an object is created or modified the datastore monitor records that modification. In this manner, a log of writes is generated. In various embodiments, this process may use efficient “copy on write’ procedures. In some embodiments, when a sufficient amount of data has changed, the data read by the application (e.g., stored in a cache) may be refreshed. At any future time, process A may consult the datastore monitor to determine what changes have been made to the datastore since the monitor was acquired.

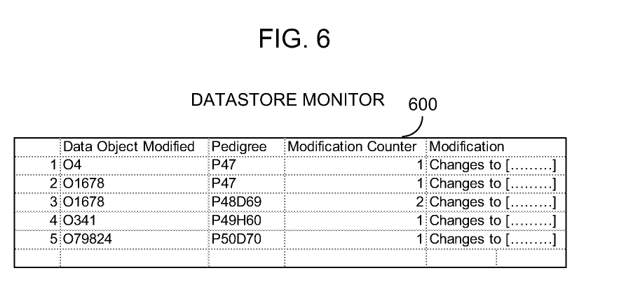

FIG. 6 shows a schematic diagram 600 of a datastore monitor according to an embodiment of the present invention. As shown, the datastore monitor includes a table that lists modifications to data objects in data store (P) after the datastore monitor has been acquired. The table includes a numbering of the modifications (1, 2, etc.), data object identifiers (O4, O1678, etc.), pedigrees (P47, P48D69, etc.), and a modification counter (1, 1, 2, etc.).

The second and third rows of the exemplary datastore monitor 600 refer to the same data object O1678. In this case, the datastore monitor shows the state of the object residing on a PDA of a first modification after having the datastore monitor initiated (indicated by the pedigree P47 and change counter of 1), and a subsequent change to the same data object after a synchronization with a desktop (indicated by the pedigree P48D69 and a change counter of 2). The application may consult the datastore monitor at anytime to determine what changes have been made to the datastore since the monitor was acquired. If sufficient data has changed, the application may refresh its cached data. In this case, the application may view the datastore, determine what has been modified, and decide whether enough data has changed to refresh its cache. For efficiency, a datastore may not to be implemented simply as set of object monitors. Instead it is modeled as (the initially) empty set of changes that have occurred to the datastore since the monitor was acquired. This allows efficient “copy on write” semantics to be used to track changes to the datastore. Further a datastore monitor may be used in the same fashion that an object monitor is used. By this it intended to mean that a datastore monitor can function as disclosed in FIG. 4.

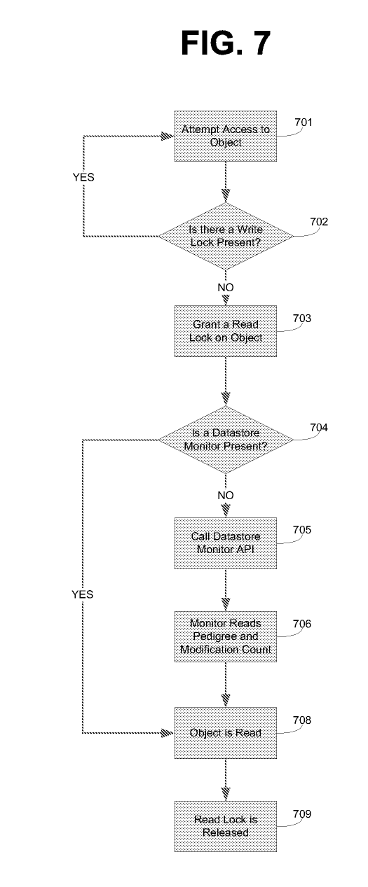

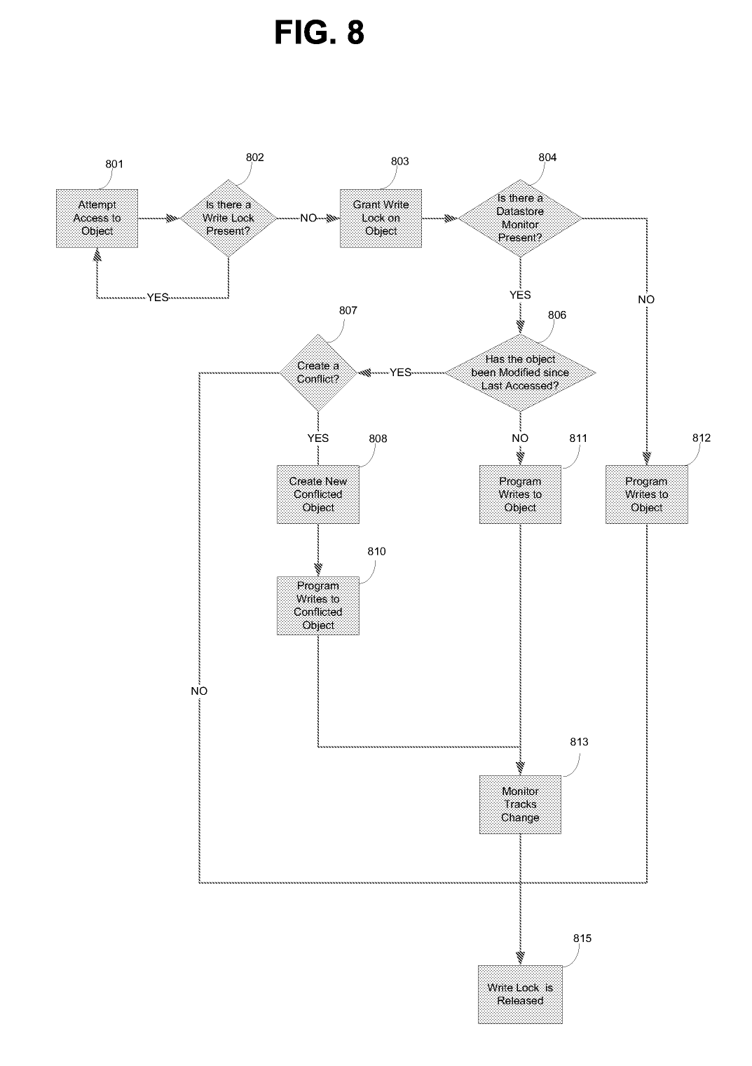

To further highlight the similarities in functionality between the datastore monitor and the object monitor, as previously presented, FIGS. 7 and 8 are included and described within. FIG. 7 describes a read process using a datastore monitor in an almost analogous fashion as previously presented for FIG. 3. FIG. 7's steps 701 through 703 are analogous to steps 301 through 303. At step 704 the system checks to see if there is already a monitor on the datastore. In FIG. 3 this step does not exist as a monitor for an object is called every time for a read process where as with the datastore monitor the monitor is always extant after creation or is explicitly removed. If no monitor is present the system advances directly to step 708 where the object is read, which is analogous to step 308. Steps 705, 706, 708 and 709 are analogous respectfully to steps 305, 306, 308 and 309. FIG. 8 is an extension of FIG. 4. Further FIG. 8 has not additional steps as shown in FIG. 8. Rather the distinguishing factors is the removal of certain steps from FIG. 4. Steps 801-804, 806-808, 810-813 and 815 are analogous to 401-404, 406-408, 410-413 and 415. Steps 413 and 414 do not have analogous steps in FIG. 8, this is due to the fact that as the monitor is always extant as previously mention for the datastore monitor there is no deletion of the monitor and then calling a new monitor.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention.

Further, although the invention has been described herein with reference to particular structure, materials and/or embodiments, the invention is not intended to be limited to the particulars disclosed herein. In particular, while the invention has been described with reference to portable devices such as personal digital assistants, mobile phones, smart phones, camera phones, pocket personal computers and the like, the invention applies equally to other devices able to execute software instructions and containing data stores, devices having embedded systems (referred to as ‘information appliances’) including, for example, small televisions, media players, set top boxes, automotive navigation devices, GPS devices and portable gaming devices (e.g., Sony Play Station®), personal computers, servers or any computational device that can execute software. In addition, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of providing data concurrency in a data store having a plurality of data objects, the method comprising the steps of:
requesting a modification of a data object within the datastore using an application process;
establishing a read lock on the data object;
initializing an object monitor adapted to detect changes to the data object; and
releasing the read lock to allow other concurrent processes to write to the data object wherein the object monitor detects if any of the concurrent processes overwrite the data object.

2. The method of claim 1, further comprising:
recording a current pedigree and at least one counter to track modifications of the data object before the read lock is released using the object monitor.

3. The method of claim 2, further comprising:
detecting an overwrite by a concurrent process by comparing a pedigree and a counter to track modifications stored by the process with what is stored by the monitor.

4. The method of claim 2, wherein the pedigree of the data object includes at least a node identifier and a synchronization count.

5. The method of claim 1, wherein the data store is located on a portable computing device.

6. A method of creating and or detecting conflicts in a data store using an object monitor comprising the steps:
determining whether to make edits to a data object in the data store using an application process;
establishing a read lock on the data object;
determining, using an object monitor applied to the data object when it was read from the data object, whether the data object has been modified between commencement and finalization of the edits; and
creating a new conflicted version of the data object if it is determined that the data object has been modified.

7. The method of claim 6, further comprising:
if it is determined that the data object has not been modified between commencement and finalization of the edits, overwriting the data object.

8. The method of claim 6, wherein the object monitor determines that the data object has been modified between commencement and finalization of the edits by comparing a pedigree and modification counter of the data object at the time of finalization to a pedigree of the data object at the commencement of editing.

9. The method of claim 6, further comprising:
determining whether to create a conflicted version causing no edits to be committed and the read lock to be released.

10. The method of claim 6, wherein the data store is located on a portable computing device.

11. A method of providing data concurrency in a data store having a plurality of data objects, the method comprising the steps of:
establishing a read lock on the data store;
initializing a datastore monitor adapted to detect changes to the data store;
reading all data objects in the data store; and
releasing the read lock on the data store to allow other concurrent processes to write to the data store wherein the datastore monitor detects if any of the concurrent processes overwrite one or more data objects in the data store.

12. The method of claim 11, further comprising:
recording, using the datastore monitor, all modifications and additions to the data store.

13. The method of claim 12, wherein the datastore monitor comprises a log of the modifications and additions to the data store.

14. The method of claim 13, wherein the datastore monitor is initially set empty.

15. The method of claim 11, further comprising:
refreshing the read data object data when a sufficient amount of data has changed.

16. A method of providing data concurrency in a data store having a plurality of data objects, the method comprising the steps of:
requesting a modification of a data object within the data store using an application process;
establishing a read lock on the data object;
initializing an object monitor adapted to detect changes to the data object;
releasing the read lock, allowing other concurrent processes to write to the data object;
obtaining a request from a user to process finalized edits made to the data object;
reestablishing a read lock on the data object;
determining, using the object monitor, whether the data object has been modified between commencement and finalization of the edits; and
creating a new version of the data object if it is determined that the data object has been modified.

17. The method of claim 16, further comprising:
recording a current pedigree and modification counter of the data object before the read lock is released using the object monitor.

18. The method of claim 16, further comprising:
if it is determined that the data object has not been modified between commencement and finalization of the edits, overwriting the data object using the finalized edits.

19. The method of claim 16, wherein the object monitor determines that the data object has been modified between commencement and finalization of the edits by comparing a pedigree and modification counter of the data object at the time of finalization to a pedigree and object counter of the data object at the commencement of editing.

20. A computing device comprising:
a transceiver adapted to provide data communication with other computing devices;
a data store for storing one or more data objects; and
a processor adapted to establish communication with the other computing devices via the transceiver and to execute an application process and an object monitor, the application process being adapted to:
receive requests to modify a data object within the data store;
establish a read lock on the data object within the data store;
initialize an object monitor for detecting changes to the data object; and
release the read lock wherein the object monitor detects if a concurrent process or other computing device overwrites the data object.

21. The computing device of claim 20, wherein the object monitor is adapted to record a pedigree and modification counter of the data object before the read lock is released.

22. The computing device of claim 20, wherein the computing device is portable.

23. A computing device comprising:
a transceiver adapted to provide data communication with other computing devices;
a data store for storing one or more data objects; and
a processor adapted to establish communication with the other computing devices via the transceiver and to execute an application process and a datastore monitor, the application process being adapted to:
receive a request to modify a data object within the data store;
establish a read lock on the data store;
initialize a datastore monitor adapted to detect changes to the data store;
read all data objects in the data store; and
release the read lock on the data store to allow other concurrent processes to write to the data store wherein the datastore monitor detects if a concurrent process or other computing device overwrites one or more data objects in the data store.

24. The computing device of claim 23, wherein the datastore monitor is adapted to record all modifications and additions to the data store.

25. The computing device of claim 23, wherein the datastore monitor comprises a log of the modifications and additions to the data store.
